(19) United States
(12) Patent Application Publication
(10) Pub. No.: US 2026/0023844 A1
(43) Pub. Date: Jan. 22, 2026

(54) MALICIOUS ACTOR MODEL TRAINING USING THREAT INTELLIGENCE RECOMMENDATIONS

(71) Applicant: OKTA, INC., SAN FRANCISCO, CA (US)

(72) Inventor: Béatrice Ségolène Marie MOISSINAC, White Plains, NY (US)

(21) Appl. No.: 18/779,970

(22) Filed: Jul. 22, 2024

(51) Int. Cl. G06F 21/55; G06F 21/31

(52) U.S. Cl. CPC G06F 21/552; G06F 21/31; G06F 2221/2103

(57) ABSTRACT

In some identity management systems, to train a machine learning (ML) model to detect malicious actors, a model training service may receive a set of training data that is automatically labeled with a first label and a second label in response to an authentication challenge. The model training service may use a subset of the training data (e.g., that is labeled with the first label) and label the subset with the second label based on respective training data elements satisfying a threshold to obtain a set of updated training data. Moreover, the model training service may receive a set of pre-labeled data that is labeled as being associated with a respective malicious actor. The model training service may then train an ML model using both the set of updated training data and the set of pre-labeled data to obtain an indication that a respective user is a malicious actor.

### FIELD OF TECHNOLOGY

The present disclosure relates generally to identity management, and more specifically to malicious actor model training using threat intelligence recommendations.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

In some systems, malicious actors may attempt to gain access to applications, devices, and the like. For example, malicious actors may attempt to input login or authentication information to gain access to a respective service or device. In some cases, to prevent malicious actors from gaining access to a service, an identity management system may implement an authentication challenge for the malicious actor to complete. In some examples, the authentication challenge may be successfully completed by a real user (e.g., a human rather than malicious actor that is pretending to be a real user). However, in some cases, malicious actors may be capable of successfully completing authentication challenges, resulting in services being vulnerable to malicious actors gaining access to the respective services which can result in data leaks, security breaches, and other types of cybersecurity attacks.

### SUMMARY

A method for training a machine learning (ML) model by an apparatus is described. The method may include receiving a set of training data for training the ML model to detect malicious actors, the set of training data including data that is automatically labeled with a first label or a second label in response to an authentication challenge, labeling, with the second label, a subset of training data in the set of training data that is labeled with the first label to obtain a set of updated training data, where labeling a respective training data element with the second label is based on the respective training data element satisfying a threshold, receiving, from a data store, a set of labeled data including data that is labeled as being associated with a respective malicious actor, and obtaining, from the ML model, an indication that a respective user is a malicious actor, where the ML model is trained using both the set of updated training data and the set of labeled data.

An apparatus for training an ML model is described. The apparatus may include one or more memories storing processor executable code, and one or more processors coupled with the one or more memories. The one or more processors may individually or collectively be operable to execute the code to cause the apparatus to receive a set of training data for training the ML model to detect malicious actors, the set of training data including data that is automatically labeled with a first label or a second label in response to an authentication challenge, labeling, with the second label, a subset of training data in the set of training data that be labeled with the first label to obtain a set of updated training data, where labeling a respective training data element with the second label is based on the respective training data element satisfying a threshold, receive, from a data store, a set of labeled data including data that is labeled as being associated with a respective malicious actor, and obtain, from the ML model, an indication that a respective user is a malicious actor, where the ML model is trained using both the set of updated training data and the set of labeled data.

Another apparatus for training an ML model is described. The apparatus may include means for receiving a set of training data for training the ML model to detect malicious actors, the set of training data including data that is automatically labeled with a first label or a second label in response to an authentication challenge, means for labeling, with the second label, a subset of training data in the set of training data that is labeled with the first label to obtain a set of updated training data, where labeling a respective training data element with the second label is based on the respective training data element satisfying a threshold, means for receiving, from a data store, a set of labeled data including data that is labeled as being associated with a respective malicious actor, and means for obtaining, from the ML model, an indication that a respective user is a malicious actor, where the ML model is trained using both the set of updated training data and the set of labeled data.

A non-transitory computer-readable medium storing code for training an ML model is described. The code may include instructions executable by one or more processors to receive a set of training data for training the ML model to detect malicious actors, the set of training data including data that is automatically labeled with a first label or a second label in response to an authentication challenge, labeling, with the second label, a subset of training data in the set of training data that be labeled with the first label to obtain a set of updated training data, where labeling a respective training data element with the second label is based on the respective training data element satisfying a threshold, receive, from a data store, a set of labeled data including data that is labeled as being associated with a respective malicious actor, and obtain, from the ML model, an indication that a respective user is a malicious actor, where the ML model is trained using both the set of updated training data and the set of labeled data.

Some examples of the method, apparatus, and non-transitory computer-readable medium described herein may further include operations, features, means, or instructions for detecting that the respective training data element satisfies the threshold, where labeling the respective training data element with the second label may be based on detecting that the threshold may be satisfied.

Some examples of the method, apparatus, and non-transitory computer-readable medium described herein may further include operations, features, means, or instructions for detecting that the respective training data element satisfies the threshold for a threshold quantity of time, where labeling the respective training data element with the second label may be based on detecting that the threshold may be satisfied for the threshold quantity of time.

In some examples of the method, apparatus, and non-transitory computer-readable medium described herein, obtaining the indication may include operations, features, means, or instructions for obtaining, from the ML model, a prediction of whether the respective user may be a malicious actor.

In some examples of the method, apparatus, and non-transitory computer-readable medium described herein, a malicious actor may be a robot, a software application, an automated computer program, or any combination thereof.

In some examples of the method, apparatus, and non-transitory computer-readable medium described herein, the first label indicates that the authentication challenge was successfully completed and the second label indicates that the authentication challenge was unsuccessfully completed.

In some examples of the method, apparatus, and non-transitory computer-readable medium described herein, the threshold includes a threshold quantity of failed passwords, a threshold quantity of failed usernames, a threshold quantity of failed log-in attempts, or any combination thereof.

In some examples of the method, apparatus, and non-transitory computer-readable medium described herein, the data of the set of training data may be associated with data traffic for a respective user, a respective tenant, a respective service, a respective application, a respective website, or any combination thereof.

In some examples of the method, apparatus, and non-transitory computer-readable medium described herein, the authentication challenge may be a Completely Automated Public Turing test to tell Computers and Humans Apart (CAPTCHA) test.

In some examples of the method, apparatus, and non-transitory computer-readable medium described herein, the set of labeled data that may be received from the data store may be associated with a type of cybersecurity attack.

In some examples of the method, apparatus, and non-transitory computer-readable medium described herein, the ML model may be trained for a type of cybersecurity attack.

In some examples of the method, apparatus, and non-transitory computer-readable medium described herein, the authentication challenge may be associated with an authentication server.

### BRIEF DESCRIPTION OF THE DRAWINGS

FIG. 1 illustrates an example of a computing system that supports malicious actor model training using threat intelligence recommendations in accordance with aspects of the present disclosure.

FIG. 2 shows an example of a computing system that supports malicious actor model training using threat intelligence recommendations in accordance with aspects of the present disclosure.

FIG. 3 shows an example of a process flow that supports malicious actor model training using threat intelligence recommendations in accordance with aspects of the present disclosure.

FIG. 4 shows a block diagram of an apparatus that supports malicious actor model training using threat intelligence recommendations in accordance with aspects of the present disclosure.

FIG. 5 shows a block diagram of a training module that supports malicious actor model training using threat intelligence recommendations in accordance with aspects of the present disclosure.

FIG. 6 shows a diagram of a system including a device that supports malicious actor model training using threat intelligence recommendations in accordance with aspects of the present disclosure.

FIG. 7 shows a flowchart illustrating methods that support malicious actor model training using threat intelligence recommendations in accordance with aspects of the present disclosure.

### DETAILED DESCRIPTION

In some identity management systems, to gain access to a respective service (e.g., an application, a website, and the like) the identity management system may prompt a user to complete an authentication challenge. In some cases, an authentication challenge may automatically label a user with a first label to indicate that the user is a human (e.g., a real person) or with a second label to indicate that the user is a malicious actor. In some examples, a Completely Automated Public Turing test to tell Computers and Humans Apart (CAPTCHA) test may be an example of a type of authentication challenge that users are prompted to complete when logging in to services. For example, as part of a login flow, a service may present a user with a CAPTCHA test before granting the user access to the service. Therefore, services may prevent malicious actors from being granted access due to failing an authentication challenge. However, in some cases, malicious actors may pass authentication challenges, and thus be automatically labeled as being a human user. For example, a malicious actor may be a robot, a software application, an automated computer program, or any combination thereof that would otherwise fail an authentication challenge, but can be trained to pass authentication challenges to gain access to services.

To ensure that malicious actors are unable to gain access to services, the techniques of the present disclosure may describe training a machine learning (ML) model to detect malicious actors. For example, a model training service may receive a set of training data for training a ML model that includes data that is automatically labeled with a pass label or a failure label in response to an authentication challenge. The model training service may then obtain a set of updated training data by relabeling a subset of the training data that is labeled with the failure label (e.g., based on respective training data elements satisfying a threshold). For example, the model training service may relabel a training data element that the authentication challenge automatically labeled with the pass label (and that satisfies a threshold) with the failure label based on the training data element satisfying the threshold. Moreover, the model training service may receive a set of labeled data, from a data store, that is associated with a respective malicious actor. For example, the set of labeled may include data that is prelabeled as being associated with malicious actors. The model training service may then train an ML model with both the set of updated training data and the set of labeled data to obtain an indication of whether a respective user is a malicious actor.

In some examples, the model training service may relabel a respective training data element based on detecting that the respective training data element satisfies the threshold. For example, a respective training data element may indicate a user that passed the authentication challenge and has over a threshold quantity (e.g., 250) failed password attempts within a threshold quantity of time (e.g., 72 hours). Thus, the model training service may relabel the respective training data element with a failed label, within a set of updated training data, to indicate that the user associated with the respective training data element is likely a malicious actor. Moreover, the set of labeled data may include data associated with a respective cybersecurity attack. For example, the set of labeled data may be a set of data collected by a service during a cybersecurity attack such that all the data can be labeled as being associated with a malicious actor. Thus, the ML model may use the set of updated training data and the set of labeled data to generate predictions of whether a respective user that is attempting to gain access to a service is a malicious actor.

The techniques of the present disclosure may ensure that services from various organizations remain secure from malicious actors. For example, if a malicious actor gains access to a service, the malicious actor may be capable of gaining access to confidential information, private information associated with the users of the service, or even prevent legitimate users from accessing the service. Thus, the techniques of the present disclosure may ensure that malicious actors can be detected even after passing an authentication challenge. Moreover, the techniques of the present disclosure may provide various approaches for detecting a malicious actor that passes an authentication challenge in order to provide improved security for services.

Aspects of the disclosure are initially described in the context of a computing system. Additional aspects of the disclosure are described with reference to a computing system and a process flow. Aspects of the disclosure are further illustrated by and described with reference to apparatus diagrams, system diagrams, and flowcharts that relate to malicious actor model training using threat intelligence recommendations.

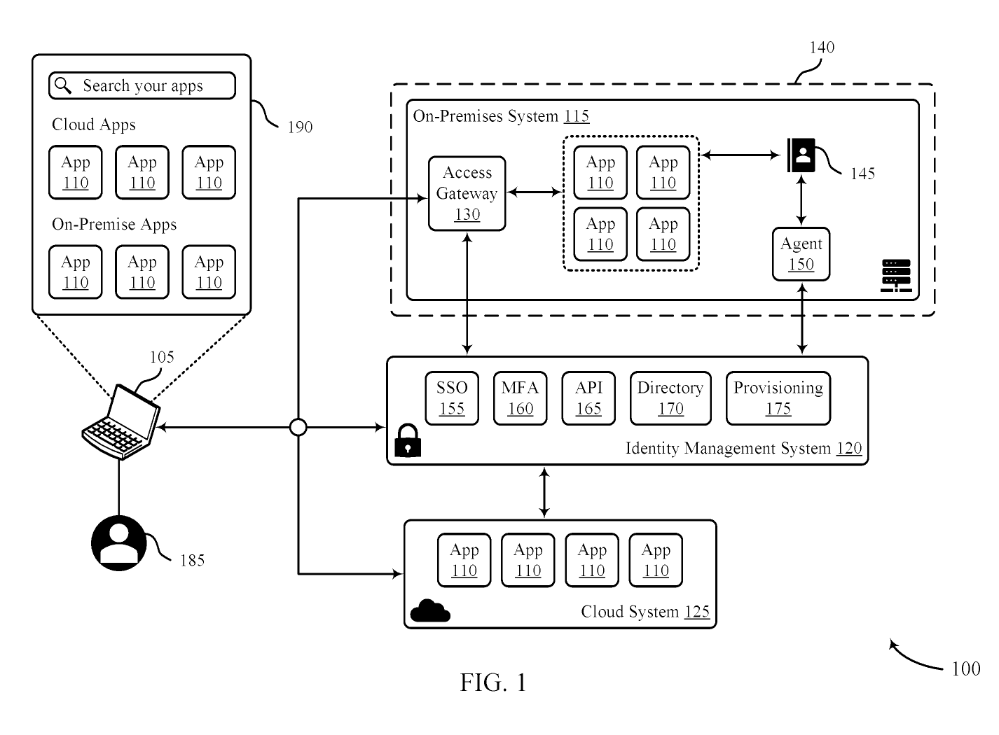

FIG. 1 illustrates an example of a computing system 100 that supports malicious actor model training using threat intelligence recommendations in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, ML, artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user’s request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user’s request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user’s identity by comparing the credentials provided by the user 185 to credentials associated with the user’s account. For example, one or more credentials associated with the user’s account may be registered with the IdP (e.g., previously registered, or otherwise authorized for authentication of the user’s identity via the IdP). The IdP may generate a security token (such as a SAML token or Oath 2.0 token) containing information associated with the identity and/or authentication status of the user 185 based on successful authentication of the user’s identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization’s APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee’s accounts and revoke the employee’s access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

In some examples of the identity management system 120, to gain access to a respective service (e.g., an application 110, a website, and the like) the identity management system 120 may prompt a user 185 to complete an authentication challenge. For example, during a login flow to an application 110 the identity management system 120 may provide a user with an authentication challenge such as a CAPTCHA test or a prompt for an input as part of an MFA service 160. If a user fails the authentication challenge the identity management system 120 may deny the user access to the respective application 110 and if the user passes the authentication challenge and provides the correct login information, the user may be granted access to the application 110. However, in some cases, malicious actors that should fail the authentication challenge may be capable of passing authentication challenges, thus automatically being labeled as a human user. For example, a malicious actor may be a robot, a software application, an automated computer program, or any combination thereof that can be trained to pass authentication challenges to gain access to services.

Thus, to ensure that malicious actors are unable to gain access to services, the techniques of the present disclosure may describe training an ML model to detect malicious actors. For example, a model training service may receive a set of training data for training an ML model that includes data that is automatically labeled with a pass label or a failure label in response to an authentication challenge. The model training service may then obtain a set of updated training data by relabeling a subset of the training data labeled with the failure label based on respective training data elements satisfying a threshold. For example, the model training service may relabel a training data element that the authentication challenge automatically labeled with the pass label and that satisfies a threshold with the failure label based on the training data element satisfying the threshold. Moreover, the model training service may receive a set of labeled data from a data store that is associated with a respective malicious actor. For example, the set of labeled may include data that is prelabeled as being associated with malicious actors. The model training service may then train an ML model with both the set of updated training data and the set of labeled data to obtain an indication of whether a respective user is a malicious actor. Thus, the techniques of the present disclosure may ensure that malicious actors can be detected even after passing an authentication challenge. Moreover, the techniques of the present disclosure may provide various techniques for detecting a malicious actor that pass an authentication challenge to provide improved security for services.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

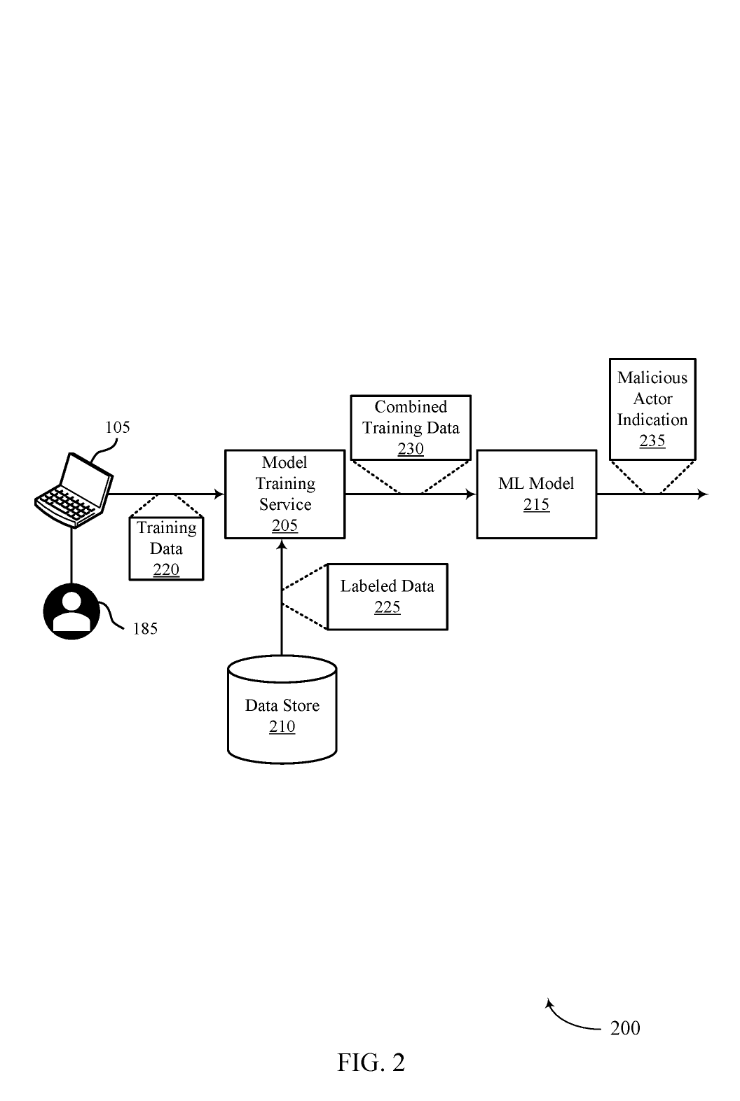

FIG. 2 shows an example of a computing system 200 that supports malicious actor model training using threat intelligence recommendations in accordance with aspects of the present disclosure. In some examples, the computing system 200 may implement or be implemented by the system 100. In some cases, the computing system 200 may be performed by devices or services described herein with reference to FIG. 1. Further, the computing system 200 may include a computing device 105 that is operated by a user 185, a model training service 205, a data store 210, and an ML model 215.

In some examples, users 185 operating on a computing device 105 may attempt to gain access to services by providing login information. For example, when accessing an application, a user 185 may have to provide login credentials such as a username and password to gain access to the application. In some cases, to ensure that the user 185 is a real user and not a malicious actor, the user 185 may have to pass an authentication challenge. For example, a user 185 may have to provide an input from an MFA service (e.g., a passkey from an authenticator application) or pass a CAPTCHA test. Further, the authentication challenge may ensure that the user 185 is not a malicious actor such as a robot (e.g., referred to as a bot), a software application, or an automated computer program. In some cases, the authentication challenge such as a CAPTCHA test may be a type of challenge-response test that can determine whether a user is a human. For example, the CAPTCHA test may have a user 185 solve a simple puzzle or enter text from a distorted image that a non-human user 185 (e.g., a malicious actor) may have trouble solving or may be unable to solve. However, some malicious actors that are non-human users 185 may be trained to solve authentication challenges such as CAPTCHA tests. For example, a malicious actor may be associated with some AI or ML (e.g., AI/ML) services that are trained on various types of authentication challenges such that the malicious actor that is a non-human user 185 can pass the authentication challenge.

After an authentication challenge, the system executing the authentication challenge may automatically label a respective user 185 with a first label that indicates the respective user 185 passed the authentication challenge and is a real user 185 (e.g., a pass label) or a second label that indicates that the respective user 185 failed the authentication challenge and is a non-human user 185 (e.g., a failure label). However, if a malicious actor passes the authentication challenge, the authentication challenge may automatically label the malicious actor with the first label to indicate that the user 185 is a human user 185, thus resulting in the malicious actor gaining access to a service or application. To prevent malicious actors from gaining access to services or applications, the techniques of the present disclosure may describe training an ML model 215 to detect malicious actors relatively more accurately via authentication challenges.

To train the ML model 215, the model training service may receive a set of training data 220 from a computing device operated by a user 185 of an organization. Additionally, or alternatively, the model training service 205 may receive the set of training data 220 from a system that stores login traffic from an application or a service. For example, the set of training data 220 may include login traffic that is automatically labeled in response to an authentication challenge performed when users 185 attempt to gain access to respective services or applications. Further, in some cases, elements of the set of training data 220 may correspond to IP addresses of users 185 that attempt to login or access the respective services or applications. Moreover, the elements of the set of training data 220 may include indications of the automatic label from the authentication challenge. Additionally, or alternatively, the elements of the set of training data 220 may include one or more additional attributes such as indications of whether a respective user 185 entered a correct username or password. Therefore, an element of the set of training data 220 may indicate various attributes such as the IP address of a user 185, a label automatically assigned to the user 185 in response to an authentication challenge, an indication of whether the correct login credentials were provided, or any combination thereof. In some cases, the set of training data 220 may also be associated with a respective user 185, a respective tenant of a multi-tenant system, a respective service, a respective application, a respective website, or any combination thereof. Moreover, the authentication challenge may be associated with an authentication server that automatically labels the result of the authentication challenge.

In some cases, the set of training data 220 may be a sample of the login traffic stored and the model training service 205 may use bootstrapping techniques to further generate the set of training data 220. Bootstrapping may assist in training the ML model 215 on generating prediction on unseen data. For example, the model training service 205 may receive a sample of login traffic data that are automatically labeled with a first or second label in response to an authentication challenge (e.g., data elements are labeled as either passing or failing an authentication challenge). The model training service 205 may then generate a sample of the login traffic data sample and calculate statistical parameters and repeat the process multiple times to refine the set of training data 220.

In some examples, to further refine the set of training data 220, the model training service 205 may relabel a subset of training data elements to obtain a set of updated training data. For example, the model training service 205 may separate the set of training data 220 into a first set of data elements that are labeled as having failed an authentication challenge and a second set of data elements that are labeled as having passed an authentication challenge. In some cases, the model training service 205 may refrain from altering the first set of data elements that are labeled as having failed an authentication challenge to prevent possible mislabeling a malicious actor as a real user 185. For example, if a data element in the set of training data 220 is labeled as having failed an authentication challenge, the model training service 205 may not alter the respective data element. In some other cases, if a data element in the set of training data 220 is labeled with a pass label, the model training service 205 may relabel the data element with a failure label based on the data element satisfying a threshold.

When relabeling respective data elements of the set of training data 220, the model training service 205 may relabel a respective data element based on an IP address associated with the respective data element satisfying a threshold. In some cases, the thresholds may include a threshold quantity of failed passwords, a threshold quantity of failed usernames, a threshold quantity of failed login attempts or any combination thereof. Moreover, if the model training service 205 detects that a respective data element of the set of training data 220 labeled with a pass label satisfies at least one threshold of a set of thresholds, the model training service 205 may relabel the respective data element with a failure label to indicate that the IP address associated with the respective data element is associated with a malicious actor. For example, a user 185 that has passed an authentication challenge (e.g., a user 185 with an IP address that is automatically labeled with a pass label by the authentication challenge) but has over 10 failed password attempts, username attempts, login attempts, or any combination thereof may have a relatively low probability of being a real human user 185 and is likely a malicious actor. Additionally, or alternatively, the model training service 205 may relabel a respective data element from the set of training data 220 based on the respective data element satisfying a threshold after a quantity of time. For example, a user 185 that is labeled with a pass label in response to an authentication challenge may have a quantity of failed password attempts that is over a threshold quantity of failed password attempts after 72 hours (e.g., over 10 failed attempts within 72 hours). Thus, the model training service 205 may determine that the user 185 is a malicious actor and the model training service 205 may relabel the user 185 and the respective data element with a failure label for the authentication challenge. Thus, the techniques of the present disclosure may enable the model training service 205 to relabel training data elements with a failure label to obtain a set of updated training data that more accurately indicates and differentiates real human users 185 from malicious actors.

Further, in addition to receiving the set of training data 220 and obtaining the set of updated training data, the model training service 205 may receive a set of labeled data 225 from the data store 210. In some cases, the data store 210 may include one or more sets of data that are prelabeled by users 185 (e.g., administrative users, developers, security experts, and the like) as being associated with malicious actors. For example, an application or service may experience a cybersecurity attack where a malicious actor is successful in gaining access to the application or service. As such, traffic data collected during the cybersecurity attack may be collected and labeled by a user 185 as being associated with a respective malicious actor. Thus, the set of labeled data 225 may include data that is labeled as being associated with a respective malicious actor based on being associated with a cybersecurity attack.

Based on the model training service 205 receiving the set of labeled data 225 and obtaining the set of updated training data from the set of training data 220, the model training service 205 may generate a set of combined training data 230 to use for training the ML model 215. Therefore, the ML model 215 may use both the set of updated training data and the set of labeled data 225 to detect whether a user 185 that passes an authentication challenge is a real user 185 or a malicious actor. For example, the ML model 215 may detect or determine that a respective user 185 has a quantity of failed login attempts above an average quantity of failed login attempts for a real user 185, a respective user 185 has a similar pattern of login attempts or data traffic as the traffic from the set of labeled data 225 that is associated with a respective malicious actor, or a combination thereof. Thus, the ML model 215 may generate a malicious actor indication 235 that is a prediction of whether the respective user is a malicious actor. In some cases, if the prediction indicated via the malicious actor indication 235 is above a threshold value, an application or service may determine that the respective user 185 is a malicious actor and deny access to the respective user 185. Further, in some examples, the application or service may send an indication of the denial to the model training service 205 or the ML model 215 to further enhance the training of the ML model 215 and improve the capability of the ML model 215 to predict whether a respective user 185 is a malicious actor.

Moreover, in some cases, due to using the set of labeled data 225 that is associated with a respective cybersecurity attack, the model training service 205 may train the ML model 215 on a per cybersecurity attack basis. For example, the set of labeled data 225 may be associated with a credential stuffing attack where a malicious actor uses various stolen login credentials to attempt to gain access to an application or service. As such, the set of labeled data 225 may indicate a relatively large quantity of login attempts before a user 185 (e.g., a malicious actor) gains access to a respective application or service. Thus, the model training service 205 may train the ML model 215 to detect malicious actors that pass authentication challenges but are associated with a high quantity (e.g., a quantity that satisfies a threshold) of login attempts. Additionally, or alternatively, the model training service 205 may train the ML model 215 on various other types of cybersecurity attacks such as denial-of-service (DOS) attacks where a malicious actor attempts to make an application or service unusable by other users 185, spoofing attacks where a malicious actor pretends to be a trusted user 185, or any other type of cybersecurity attack. In some examples, the ML model 215 may be trained on a single type of cybersecurity attach and a set of ML models may be used to detect malicious actors. In some other examples, the ML model 215 may receive various different sets of data to be trained on such that an ML model 215 can detect various cybersecurity attacks.

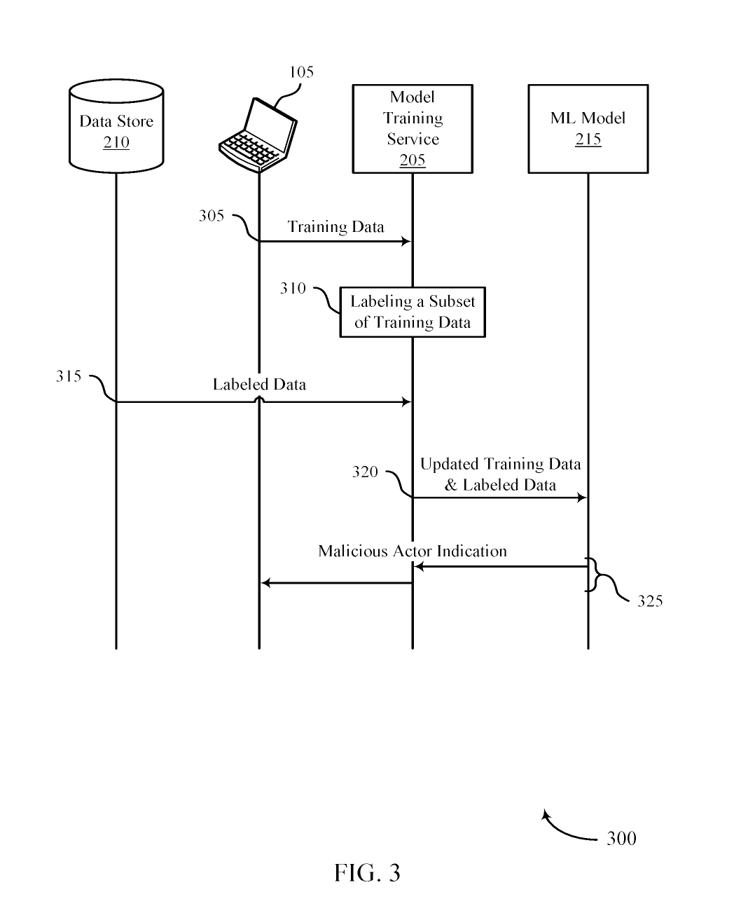

Therefore, by having the model training service 205 train the ML model 215 in accordance with the techniques of the present disclosure the capabilities of the ML model 215 to detect malicious actors may be relatively more efficient, reliable, and accurate. Thus, as malicious actors become more advanced and become capable of passing authentication challenges such as CAPTCHA tests, the techniques of the present disclosure may enable an ML model 215 to be able to detect such malicious actors. For example, in accordance with the techniques of the present disclosure, by having the model training service 205 relabel training data elements of the set of training data 220 with a failure label and combining the set of updated training data with the set of labeled data 225 that is prelabelled, the model training service 205 may be capable of training the ML model 215 to obtain a malicious actor indication 235 that is relatively more accurate and reliable. Further descriptions of the techniques of the present disclosure that can enhance the security and authentication procedures of services and applications may be described elsewhere herein, such as with reference to FIG. 3.

FIG. 3 shows an example of a process flow 300 that supports malicious actor model training using threat intelligence recommendations in accordance with aspects of the present disclosure. In some examples, the process flow 300 may implement or be implemented by the system 100, the computing system 200, or both. For example, the process flow 300 may include a computing device 105, a model training service 205, a data store 210, and an ML model 215, which may be examples of devices described herein with reference to FIGS. 1 and 2.

In the following description of the process flow 300, the operations between the computing device 105, the model training service 205, the data store 210, and the ML model 215 may be performed in different orders or at different times. Some operations may also be left out of the process flow 300, or other operations may be added. Although the computing device 105, the model training service 205, the data store 210, and the ML model 215 are shown performing the operations of the process flow 300, some aspects of some operations may also be performed by one or more other wireless devices.

At 305, the model training service 205 may receive, from the computing device 105, a set of training data for training the ML model 215 to detect malicious actors. Further, the set of training data may include data that is automatically labelled with a first label or a second label in response to an authentication challenge. In some cases, the data of the set of training data may be associated with data traffic for a respective user, a respective tenant, a respective service, a respective application, a respective website, or any combination thereof. Further, the authentication challenge may be an example of a CAPTCHA test and the authentication challenge may be associated with an authentication server. Moreover, in some examples, the first label from the authentication challenge may indicate that the authentication challenge was successfully completed and the second label from the authentication challenge may indicate that the authentication challenge was unsuccessfully completed. Additionally, or alternatively, a malicious actor may be an example of a robot, a software application, an automated computer program, or any combination thereof.

At 310, the model training service 205 may label, with the second label, a subset of training data in the set of training data that is labeled with the first label to obtain a set of updated training data. Moreover, labelling a respective training data element with the second element may be based on the respective training data element satisfying a threshold. For example, the model training service 205 may detect that the respective training data element satisfies the threshold and labelling the respective training data element with the second label is based on the model training service 205 detecting that the threshold is satisfied. In another example, the model training service 205 may detect that the respective training data element satisfies the threshold for a threshold quantity of time and labelling the respective training data element with the second label is based on the model training service 205 detecting that the threshold is satisfied for the threshold quantity of time. Further, in some cases, the threshold may be one of a set of thresholds that include a threshold quantity of failed passwords, a threshold quantity of failed usernames, a threshold quantity of failed log-in attempts, or any combination thereof. As such, the model training service 205 may detect that a respective training data element satisfies the element based on satisfying at least one of the set of thresholds described herein.

At 315, the model training service 205 may receive, from the data store 210, a set of labeled data that includes data that is labeled as being associated with a respective malicious actor. In some cases, the set of labeled data that the model training service 205 may receive from the data store 210 may be associated with a type of cybersecurity attack. At 320, the model training service 205 may transmit, to the ML model 215, a combined set of training data that includes both the set of updated training data and the set of labeled data to train the ML model 215. Further, in some cases, the ML model 215 may be trained for a type of cybersecurity attack or on a per cybersecurity attack basis. At 325, the model training service 205 and the computing device 105 may obtain, from the ML model 215, an indication that a respective user is a malicious actor where the ML model 215 is trained, at 320, using both the set of updated training data and the set of labeled data. Moreover, the indication that the respective user is a malicious actor may be based on the model training service 205 transmitting the combined set of training to the ML model 215 at 320. Further, in some cases, obtaining the indication may include the model training service 205 or the computing device 105 obtaining, from the ML model 215, a prediction of whether the respective user is a malicious actor.

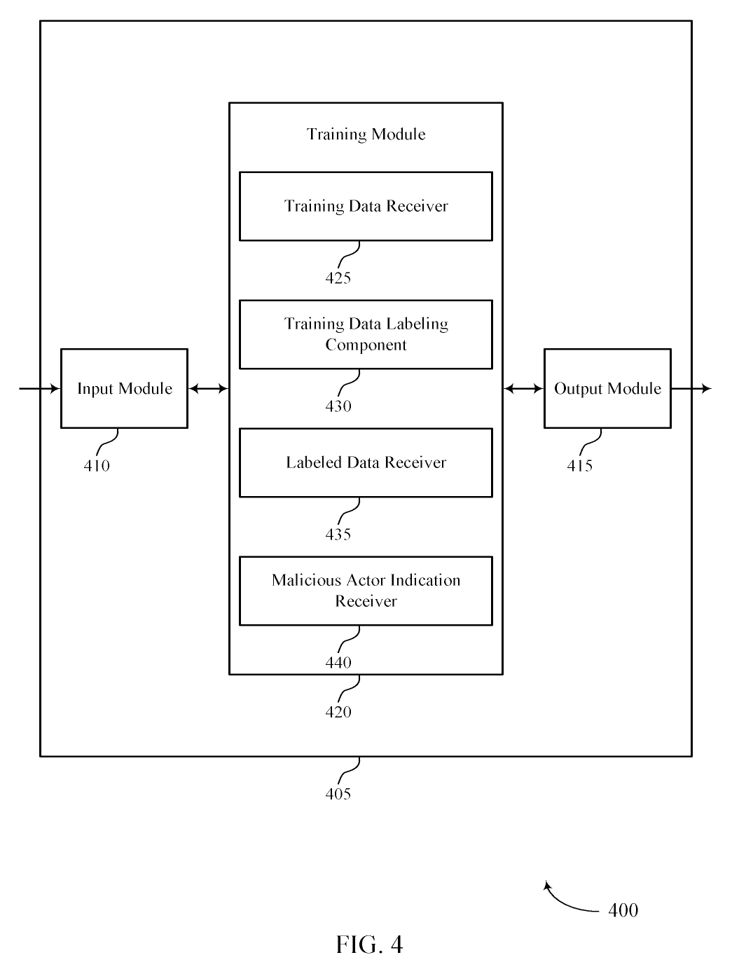

FIG. 4 shows a block diagram 400 of a device 405 that supports malicious actor model training using threat intelligence recommendations in accordance with aspects of the present disclosure. The device 405 may include an input module 410, an output module 415, and a training module 420. The device 405, or one or more components of the device 405 (e.g., the input module 410, the output module 415, the training module 420), may include at least one processor, which may be coupled with at least one memory, to support the described techniques. Each of these components may be in communication with one another (e.g., via one or more buses).

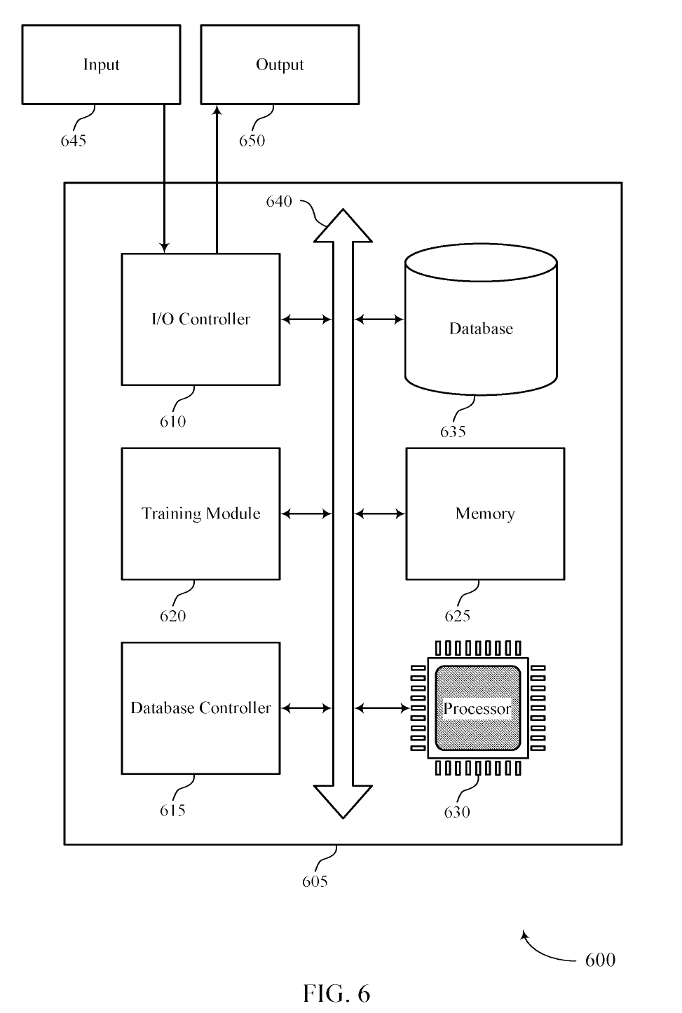

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the training module 420 to support malicious actor model training using threat intelligence recommendations. In some cases, the input module 410 may be a component of an input/output (I/O) controller 610 as described with reference to FIG. 6.

The output module 415 may manage output signals for the device 405. For example, the output module 415 may receive signals from other components of the device 405, such as the training module 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the training module 420 may include a training data receiver 425, a training data labeling component 430, a labeled data receiver 435, a malicious actor indication receiver 440, or any combination thereof. In some examples, the training module 420, or various components thereof, may be configured to perform various operations (e.g., receiving, monitoring, transmitting) using or otherwise in cooperation with the input module 410, the output module 415, or both. For example, the training module 420 may receive information from the input module 410, send information to the output module 415, or be integrated in combination with the input module 410, the output module 415, or both to receive information, transmit information, or perform various other operations as described herein.

The training module 420 may support training an ML model in accordance with examples as disclosed herein. The training data receiver 425 may be configured to support receiving a set of training data for training the ML model to detect malicious actors, the set of training data including data that is automatically labeled with a first label or a second label in response to an authentication challenge. The training data labeling component 430 may be configured to support labeling, with the second label, a subset of training data in the set of training data that is labeled with the first label to obtain a set of updated training data, where labeling a respective training data element with the second label is based on the respective training data element satisfying a threshold. The labeled data receiver 435 may be configured to support receiving, from a data store, a set of labeled data including data that is labeled as being associated with a respective malicious actor. The malicious actor indication receiver 440 may be configured to support obtaining, from the ML model, an indication that a respective user is a malicious actor, where the ML model is trained using both the set of updated training data and the set of labeled data.

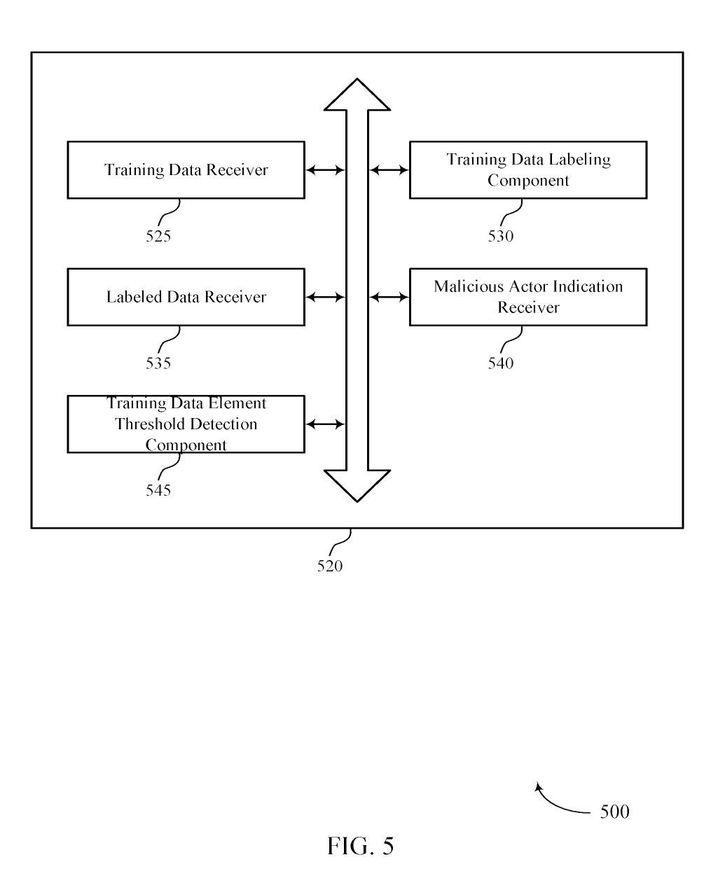

FIG. 5 shows a block diagram 500 of a training module 520 that supports malicious actor model training using threat intelligence recommendations in accordance with aspects of the present disclosure. The training module 520 may be an example of aspects of a training module or a training module 420, or both, as described herein. The training module 520, or various components thereof, may be an example of means for performing various aspects of malicious actor model training using threat intelligence recommendations as described herein. For example, the training module 520 may include a training data receiver 525, a training data labeling component 530, a labeled data receiver 535, a malicious actor indication receiver 540, a training data element threshold detection component 545, or any combination thereof. Each of these components, or components of subcomponents thereof (e.g., one or more processors, one or more memories), may communicate, directly or indirectly, with one another (e.g., via one or more buses).

The training module 520 may support training an ML model in accordance with examples as disclosed herein. The training data receiver 525 may be configured to support receiving a set of training data for training the ML model to detect malicious actors, the set of training data including data that is automatically labeled with a first label or a second label in response to an authentication challenge. The training data labeling component 530 may be configured to support labeling, with the second label, a subset of training data in the set of training data that is labeled with the first label to obtain a set of updated training data, where labeling a respective training data element with the second label is based on the respective training data element satisfying a threshold. The labeled data receiver 535 may be configured to support receiving, from a data store, a set of labeled data including data that is labeled as being associated with a respective malicious actor. The malicious actor indication receiver 540 may be configured to support obtaining, from the ML model, an indication that a respective user is a malicious actor, where the ML model is trained using both the set of updated training data and the set of labeled data.

In some examples, the training data element threshold detection component 545 may be configured to support detecting that the respective training data element satisfies the threshold, where labeling the respective training data element with the second label is based on detecting that the threshold is satisfied.

In some examples, the training data element threshold detection component 545 may be configured to support detecting that the respective training data element satisfies the threshold for a threshold quantity of time, where labeling the respective training data element with the second label is based on detecting that the threshold is satisfied for the threshold quantity of time.

In some examples, to support obtaining the indication, the malicious actor indication receiver 540 may be configured to support obtaining, from the ML model, a prediction of whether the respective user is a malicious actor.

In some examples, a malicious actor is a robot, a software application, an automated computer program, or any combination thereof.

In some examples, the first label indicates that the authentication challenge was successfully completed and the second label indicates that the authentication challenge was unsuccessfully completed.

In some examples, the threshold includes a threshold quantity of failed passwords, a threshold quantity of failed usernames, a threshold quantity of failed log-in attempts, or any combination thereof.

In some examples, the data of the set of training data is associated with data traffic for a respective user, a respective tenant, a respective service, a respective application, a respective website, or any combination thereof.

In some examples, the authentication challenge is a Completely Automated Public Turing test to tell Computers and Humans Apart (CAPTCHA) test.

In some examples, the set of labeled data that is received from the data store is associated with a type of cybersecurity attack.

In some examples, the ML model is trained for a type of cybersecurity attack.

In some examples, the authentication challenge is associated with an authentication server.

FIG. 6 shows a diagram of a system 600 including a device 605 that supports malicious actor model training using threat intelligence recommendations in accordance with aspects of the present disclosure. The device 605 may be an example of or include components of a device 405 as described herein. The device 605 may include components for bi-directional voice and data communications including components for transmitting and receiving communications, such as a training module 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting malicious actor model training using threat intelligence recommendations). The processor 630 may be an example of a single processor or multiple processors. For example, the device 605 may include one or more processors 630.

The training module 620 may support training an ML model in accordance with examples as disclosed herein. For example, the training module 620 may be configured to support receiving a set of training data for training the ML model to detect malicious actors, the set of training data including data that is automatically labeled with a first label or a second label in response to an authentication challenge. The training module 620 may be configured to support labeling, with the second label, a subset of training data in the set of training data that being labeled with the first label to obtain a set of updated training data, where labeling a respective training data element with the second label is based on the respective training data element satisfying a threshold. The training module 620 may be configured to support receiving, from a data store, a set of labeled data including data that is labeled as being associated with a respective malicious actor. The training module 620 may be configured to support obtaining, from the ML model, an indication that a respective user is a malicious actor, where the ML model is trained using both the set of updated training data and the set of labeled data.

By including or configuring the training module 620 in accordance with examples as described herein, the device 605 may support techniques for training an ML model to detect malicious actors to support improved security and reliability of an identity management system by detecting malicious actors more efficiently, reliably, and accurately.

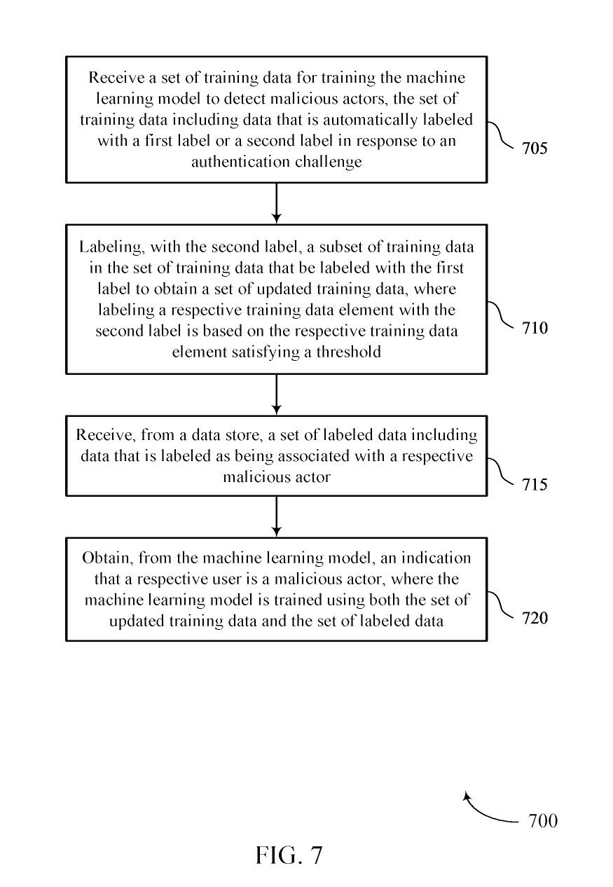

FIG. 7 shows a flowchart illustrating a method 700 that supports malicious actor model training using threat intelligence recommendations in accordance with aspects of the present disclosure. The operations of the method 700 may be implemented by a model training service or its components as described herein. For example, the operations of the method 700 may be performed by a model training service as described with reference to FIGS. 1 through 6. In some examples, a model training service may execute a set of instructions to control the functional elements of the model training service to perform the described functions. Additionally, or alternatively, the model training service may perform aspects of the described functions using special-purpose hardware.

At 705, the method may include receiving a set of training data for training the ML model to detect malicious actors, the set of training data including data that is automatically labeled with a first label or a second label in response to an authentication challenge. The operations of 705 may be performed in accordance with examples as disclosed herein. In some examples, aspects of the operations of 705 may be performed by a training data receiver 525 as described with reference to FIG. 5.

At 710, the method may include labeling, with the second label, a subset of training data in the set of training data that is labeled with the first label to obtain a set of updated training data, where labeling a respective training data element with the second label is based on the respective training data element satisfying a threshold. The operations of 710 may be performed in accordance with examples as disclosed herein. In some examples, aspects of the operations of 710 may be performed by a training data labeling component 530 as described with reference to FIG. 5.

At 715, the method may include receiving, from a data store, a set of labeled data including data that is labeled as being associated with a respective malicious actor. The operations of 715 may be performed in accordance with examples as disclosed herein. In some examples, aspects of the operations of 715 may be performed by a labeled data receiver 535 as described with reference to FIG. 5.

At 720, the method may include obtaining, from the ML model, an indication that a respective user is a malicious actor, where the ML model is trained using both the set of updated training data and the set of labeled data. The operations of 720 may be performed in accordance with examples as disclosed herein. In some examples, aspects of the operations of 720 may be performed by a malicious actor indication receiver 540 as described with reference to FIG. 5.

### The following provides an overview of aspects of the present disclosure:

Aspect 1: A method for training an ML model, comprising: receiving a set of training data for training the ML model to detect malicious actors, the set of training data comprising data that is automatically labeled with a first label or a second label in response to an authentication challenge; labeling, with the second label, a subset of training data in the set of training data that is labeled with the first label to obtain a set of updated training data, wherein labeling a respective training data element with the second label is based at least in part on the respective training data element satisfying a threshold; receiving, from a data store, a set of labeled data comprising data that is labeled as being associated with a respective malicious actor; and obtaining, from the ML model, an indication that a respective user is a malicious actor, wherein the ML model is trained using both the set of updated training data and the set of labeled data.

Aspect 2: The method of aspect 1, further comprising: detecting that the respective training data element satisfies the threshold, wherein labeling the respective training data element with the second label is based at least in part on detecting that the threshold is satisfied.

Aspect 3: The method of any of aspects 1 through 2, further comprising: detecting that the respective training data element satisfies the threshold for a threshold quantity of time, wherein labeling the respective training data element with the second label is based at least in part on detecting that the threshold is satisfied for the threshold quantity of time.

Aspect 4: The method of any of aspects 1 through 3, wherein obtaining the indication comprises: obtaining, from the ML model, a prediction of whether the respective user is a malicious actor.

Aspect 5: The method of any of aspects 1 through 4, wherein a malicious actor is a robot, a software application, an automated computer program, or any combination thereof.

Aspect 6: The method of any of aspects 1 through 5, wherein the first label indicates that the authentication challenge was successfully completed and the second label indicates that the authentication challenge was unsuccessfully completed.

Aspect 7: The method of any of aspects 1 through 6, wherein the threshold comprises a threshold quantity of failed passwords, a threshold quantity of failed usernames, a threshold quantity of failed log-in attempts, or any combination thereof.

Aspect 8: The method of any of aspects 1 through 7, wherein the data of the set of training data is associated with data traffic for a respective user, a respective tenant, a respective service, a respective application, a respective website, or any combination thereof.

Aspect 9: The method of any of aspects 1 through 8, wherein the authentication challenge is a Completely Automated Public Turing test to tell Computers and Humans Apart (CAPTCHA) test.

Aspect 10: The method of any of aspects 1 through 9, wherein the set of labeled data that is received from the data store is associated with a type of cybersecurity attack.

Aspect 11: The method of any of aspects 1 through 10, wherein the ML model is trained for a type of cybersecurity attack.

Aspect 12: The method of any of aspects 1 through 11, wherein the authentication challenge is associated with an authentication server.

Aspect 13: An apparatus for training an ML model, comprising one or more memories storing processor-executable code, and one or more processors coupled with the one or more memories and individually or collectively operable to execute the code to cause the apparatus to perform a method of any of aspects 1 through 12.

Aspect 14: An apparatus for training an ML model, comprising at least one means for performing a method of any of aspects 1 through 12.

Aspect 15: A non-transitory computer-readable medium storing code for training an ML model, the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for training a machine learning model, comprising:
receiving a set of training data for training the machine learning model to detect malicious actors, the set of training data comprising data that is automatically labeled with a first label or a second label in response to an authentication challenge;
labeling, with the second label, a subset of training data in the set of training data that is labeled with the first label to obtain a set of updated training data, wherein labeling a respective training data element with the second label is based at least in part on the respective training data element satisfying a threshold;
receiving, from a data store, a set of labeled data comprising data that is labeled as being associated with a respective malicious actor; and
obtaining, from the machine learning model, an indication that a respective user is a malicious actor, wherein the machine learning model is trained using both the set of updated training data and the set of labeled data.

2. The method of claim 1, further comprising:
detecting that the respective training data element satisfies the threshold, wherein labeling the respective training data element with the second label is based at least in part on detecting that the threshold is satisfied.

3. The method of claim 1, further comprising:
detecting that the respective training data element satisfies the threshold for a threshold quantity of time, wherein labeling the respective training data element with the second label is based at least in part on detecting that the threshold is satisfied for the threshold quantity of time.

4. The method of claim 1, wherein obtaining the indication comprises:
obtaining, from the machine learning model, a prediction of whether the respective user is a malicious actor.

5. The method of claim 1, wherein a malicious actor is a robot, a software application, an automated computer program, or any combination thereof.

6. The method of claim 1, wherein the first label indicates that the authentication challenge was successfully completed and the second label indicates that the authentication challenge was unsuccessfully completed.

7. The method of claim 1, wherein the threshold comprises a threshold quantity of failed passwords, a threshold quantity of failed usernames, a threshold quantity of failed log-in attempts, or any combination thereof.

8. The method of claim 1, wherein the data of the set of training data is associated with data traffic for a respective user, a respective tenant, a respective service, a respective application, a respective website, or any combination thereof.

9. The method of claim 1, wherein the authentication challenge is a Completely Automated Public Turing test to tell Computers and Humans Apart (CAPTCHA) test.

10. The method of claim 1, wherein the set of labeled data that is received from the data store is associated with a type of cybersecurity attack.

11. The method of claim 1, wherein the machine learning model is trained for a type of cybersecurity attack.

12. The method of claim 1, wherein the authentication challenge is associated with an authentication server.

13. An apparatus for training a machine learning model, comprising:
one or more memories storing processor-executable code; and
one or more processors coupled with the one or more memories and individually or collectively operable to execute the code to cause the apparatus to:
receive a set of training data for training the machine learning model to detect malicious actors, the set of training data comprising data that is automatically labeled with a first label or a second label in response to an authentication challenge;
labeling, with the second label, a subset of training data in the set of training data that be labeled with the first label to obtain a set of updated training data, wherein labeling a respective training data element with the second label is based at least in part on the respective training data element satisfying a threshold;
receive, from a data store, a set of labeled data comprising data that is labeled as being associated with a respective malicious actor; and
obtain, from the machine learning model, an indication that a respective user is a malicious actor, wherein the machine learning model is trained using both the set of updated training data and the set of labeled data.

14. The apparatus of claim 13, wherein the one or more processors are individually or collectively further operable to execute the code to cause the apparatus to:
detect that the respective training data element satisfies the threshold, wherein labeling the respective training data element with the second label is based at least in part on detecting that the threshold is satisfied.

15. The apparatus of claim 13, wherein the one or more processors are individually or collectively further operable to execute the code to cause the apparatus to:
detect that the respective training data element satisfies the threshold for a threshold quantity of time, wherein labeling the respective training data element with the second label is based at least in part on detecting that the threshold is satisfied for the threshold quantity of time.

16. The apparatus of claim 13, wherein, to obtain the indication, the one or more processors are individually or collectively operable to execute the code to cause the apparatus to:
obtain, from the machine learning model, a prediction of whether the respective user is a malicious actor.

17. A non-transitory computer-readable medium storing code for training a machine learning model, the code comprising instructions executable by one or more processors to:
receive a set of training data for training the machine learning model to detect malicious actors, the set of training data comprising data that is automatically labeled with a first label or a second label in response to an authentication challenge;
labeling, with the second label, a subset of training data in the set of training data that be labeled with the first label to obtain a set of updated training data, wherein labeling a respective training data element with the second label is based at least in part on the respective training data element satisfying a threshold;
receive, from a data store, a set of labeled data comprising data that is labeled as being associated with a respective malicious actor; and
obtain, from the machine learning model, an indication that a respective user is a malicious actor, wherein the machine learning model is trained using both the set of updated training data and the set of labeled data.

18. The non-transitory computer-readable medium of claim 17, wherein the instructions are further executable by the one or more processors to:
detect that the respective training data element satisfies the threshold, wherein labeling the respective training data element with the second label is based at least in part on detecting that the threshold is satisfied.

19. The non-transitory computer-readable medium of claim 17, wherein the instructions are further executable by the one or more processors to:
detect that the respective training data element satisfies the threshold for a threshold quantity of time, wherein labeling the respective training data element with the second label is based at least in part on detecting that the threshold is satisfied for the threshold quantity of time.

20. The non-transitory computer-readable medium of claim 17, wherein the instructions to obtain the indication are executable by the one or more processors to:
obtain, from the machine learning model, a prediction of whether the respective user is a malicious actor.
